(19) United States
(12) Patent Application Publication
(10) Pub. No.: US 2025/0208474 A1
(43) Pub. Date: Jun. 26, 2025

(54) FERROELECTRIC NEMATIC LIQUID CRYSTALS FOR USE IN HYBRID SLOT MODULATORS

(71) Applicant: Polaris Electro-Optics, Inc., Broomfield, CO (US)

(72) Inventor: Cory Pecinovsky, Lafayette, CO (US)

(21) Appl. No.: 18/974,549

(22) Filed: Dec. 9, 2024

Related U.S. Application Data
(63) Continuation of application No. 17/940,901, filed on Sep. 8, 2022, now abandoned.
(60) Provisional application No. 63/242,441, filed on Sep. 9, 2021.
(60) Provisional application No. 63/298,615, filed on Jan. 11, 2022.

(51) Int. Cl. G02F 1/141; G02F 1/13; G02F 1/1333; G02F 1/1337

(52) U.S. Cl. CPC G02F 1/141; G02F 1/1326; G02F 1/133734; G02F 1/133738; G02F 1/133331; G02F 2202/105

(57) ABSTRACT

Described herein are devices that uses ferroelectric nematic liquid crystals within a hybrid slot modulator. The device may comprise: (a) a slot structure on a substrate; (b) a plurality of layers on the substrate having a cavity defined therein, wherein the slot structure is located within the cavity; and (c) a ferroelectric nematic liquid crystal material disposed in the cavity over the slot structure.

### CROSS REFERENCE

This application is a continuation of U.S. patent application Ser. No. 17/940,901, filed Sep. 8, 2022, which claims the benefit of U.S. Provisional Application No. 63/242,441 filed Sep. 9, 2021 and U.S. Provisional Application No. 63/298,615 filed Jan. 11, 2022, each of which are incorporated herein by reference in their entirety.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BACKGROUND

Photonic integrated circuits allow photonic devices and electronic devices to be fabricated on a single chip. These circuits play a major role in the telecommunications industry. For example, photonic integrated circuits are used in worldwide communication networks, optical computing, optical processing, artificial intelligence, quantum computing, satellite antennas, light detection and ranging (LIDAR), and many more applications. Within photonic integrated circuits, electro-optical modulators may be used to convert information between the electrical and optical fields.

Hybrid slot modulators consist of doped silicon waveguides or metal electrodes separated by a sub-wavelength distance. Guided light is contained mainly in the distance between the waveguides, where it comes into contact an electro-optical (“EO”) material that is also deposited in between the waveguides. This creates a strong interaction between the guided light and the EO material. High performance modulators using EO polymers within the slot waveguide have been demonstrated. However, in order for EO polymers to act as modulators, large external electric fields must be applied to generate the appropriate orientation of the dipolar molecules. This poling procedure is not easily reproducible and prone to thermal instability. Therefore, there remains a need for an EO material that spontaneously organizes acentrically with large second order optical nonlinearity and is easily oriented uniformly with the polar axis perpendicular to the electrodes without large electric field poling.

### SUMMARY

Ferroelectric nematic liquid crystals (“FN materials”) are a new class of electro-optic materials that offer superior properties as compared to conventional EO materials. FN materials contain molecules with dipoles along the long axis that spontaneously assemble into polar fluids with the dipoles aligned. These polar fluids have large second order optical nonlinearities, and therefore can be used in Pockels cells as linear electro-optic materials. Due to its unique properties, FN liquid crystals can be electrically aligned within a slot modulator without the need for large electrical field poling. This substitution addresses the disadvantages associated with the required electric poling procedure, which includes variability of the electro-optic coefficient and inherent thermodynamic instability.

There are at least two possibilities for aligning the FN material within a slot modulator. First, the materials may be aligned by thin alignment layers contained within the slot structure. Second, because of the ferroelectric nature of the liquid crystal, the material can be aligned by applying a DC field on the device. In some embodiments, the DC field may be permanent. In some embodiments, the DC field may be applied long enough to create a monodomain of aligned FN material. FN liquid crystal materials can be used within both silicon organic hybrid (“SOH”) modulators and plasmonic organic hybrid (“POH”) modulators.

According to some aspects of the disclosure, provided herein is a device, comprising: a slot structure on a substrate; a plurality of layers on the substrate having a cavity defined therein, wherein the slot structure is located within the cavity; and a ferroelectric nematic (“FN”) liquid crystal material disposed in the cavity over the slot structure. The FN liquid crystal material may be aligned in the cavity over the slot structure such that a director of the FN liquid crystal material may be substantially perpendicular to a longitudinal axis of the slot structure. In some instances, the slot structure may comprise a pair of rails extending longitudinally on the substrate and spaced apart by a gap. The FN liquid crystal material may be aligned such that a director of the FN liquid crystal material may be substantially perpendicular to a longitudinal axis of the pair of rails. In some cases, the FN liquid crystal material may be aligned with aid of one or more alignment layers. The one or more alignment layers may comprise at least one of the following: a first alignment layer disposed at a first distal portion of the cavity, or a second alignment layer disposed at a second distal portion of the cavity. In some instances, the first alignment layer may be disposed on a substrate adjacent to a first portion of the FN liquid crystal material. In some instances, the second alignment layer may be disposed on another substrate covering the cavity, and the second alignment layer may be adjacent to a second portion of the FN liquid crystal material. In some cases, the another substrate is a cover glass. The anisotropy direction of the one or more alignment layers may be parallel between the substrate and the another substrate. The anisotropy direction of the one or more alignment layers may be non-parallel between the substrate and the another substrate. In some cases, one or more alignment layers may comprise a polymer. The polymer may comprise buffed polyimide or a photoalignment polymer. In some cases, one or more alignment layers may comprise silicon dioxide. The silicon dioxide may be obliquely deposited relative to an orientation of the slot structure. In some instances, the thickness of each of one or more alignment layers may be less than or equal to about 20 nanometers. In some cases, the FN liquid crystal material may be aligned with aid of a direct current (DC) bias. The DC bias may be less than or equal to 1 V/um. In some cases, the DC bias may be generated by applying a permanent DC field on the device. The strength of the DC field may be less than or equal to 1 V/um. In some cases, the FN liquid crystal material may be aligned in a passive manner by introducing doping variations in the slot structure. In some instances, the slot structure may comprise a pair of rails, and the doping variations may comprise different doping concentrations in the pair of rails. The pair of rails may comprise a first rail having a first concentration of charge carriers and a second rail having a second concentration of charge carriers that is greater or less than the first concentration. In some cases, the FN liquid crystal material may be aligned in a passive manner without requiring an external direct current (DC) bias. In some cases, the FN liquid crystal material can be aligned in the cavity over the slot structure without requiring electric field poling. In some cases, the FN liquid crystal material can be aligned in the cavity over the slot structure without requiring electric field poling having a field strength of greater about 100 V/um. The slot structure may comprise crystalline silicon. In some cases, the plurality of layers may comprise one or more dielectric materials. The plurality of layers may comprise one or more electrically conductive materials. In some instances, the substrate may comprise bulk silicon. In some instances, the slot structure may be a waveguide. The device may be a silicon-organic hybrid slot modulator. In some cases, the device can be configured for use in one or more photonics applications.

According to some aspects of the disclosure, provided herein is a device, comprising: a plurality of metal electrodes extending longitudinally on a substrate and spaced apart to define one or more slots therebetween, and a ferroelectric nematic (FN) liquid crystal material disposed over the one or more slots. In some cases, the FN liquid crystal material may be aligned such that a director of the FN liquid crystal material may be substantially perpendicular to a longitudinal axis of the plurality of metal electrodes. The plurality of metal electrodes may comprise gold. The substrate may comprise silicon or silicon dioxide. In some cases, a nanowire may be coupled through a metal taper to the one or more slots. The device may be a plasmonic phase modulator. In some instances, the FN liquid crystal material may be aligned with aid of one or more alignment layers. The one or more alignment layers may comprise at least one of the following: (1) a first alignment layer disposed at a first distal portion of the cavity, or (2) a second alignment layer disposed at a second distal portion of the cavity. In some instances, the first alignment layer may be disposed on the substrate adjacent to a first portion of the FN liquid crystal material. The second alignment layer may be disposed on another substrate covering the cavity, and the second alignment layer may be adjacent to a second portion of the FN liquid crystal material. In some cases, the another substrate may be a cover glass. The anisotropy direction of the one or more alignment layers may be parallel between the substrate and the another substrate. The anisotropy direction of the one or more alignment layers may be non-parallel between the substrate and the another substrate. In some instances, the one or more alignment layers may comprise a polymer. The polymer may comprise buffed polyimide or a photoalignment polymer. In some cases, one or more alignment layers may comprise silicon dioxide. The silicon dioxide may be obliquely deposited relative to an orientation of the slot structure. The thickness of each of the one or more alignment layers may be less than or equal to about 20 nanometers. In some instances, the FN liquid crystal material may be aligned with aid of a direct current (DC) bias. The DC bias may be less than or equal to 1 V/um. In some cases, the DC bias can be generated by applying a permanent DC field on the device. The strength of the DC field may be less than or equal to 1 V/um. The FN liquid crystal material may be aligned in the cavity over the slot structure without requiring electric field poling. In some cases, the FN liquid crystal material may be aligned in the cavity over the slot structure without requiring electric field poling having a field strength of greater about 100 V/um. In some cases, the plurality of layers may comprise one or more dielectric materials. In some cases, the plurality of layers may comprise one or more electrically conductive materials. In some instances, the substrate may comprise bulk silicon. The slot structure may be a waveguide. In some cases, the device may be a plasmonic-organic hybrid slot modulator. The device can be configured for use in one or more photonics applications.

In an aspect, provided herein is a device comprising: a strip waveguide; a substrate comprising a plurality of layers, wherein the strip waveguide is located on top of the substrate and surrounded by the substrate on both sides; and a ferroelectric nematic (FN) liquid crystal material disposed over the strip waveguide.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a cross-section view of a slot structure according to some embodiments.

FIG. 2 shows a top view of a slot structure with a gap between two rails that is filled with ferroelectric nematic (“FN”) liquid crystal material according to some embodiments.

FIG. 3 shows a cross-section view of a slot structure with FN liquid crystal material disposed over the slot structure according to some embodiments.

FIG. 4 shows a cross-section view of a slot structure, connected to two electrodes, FN liquid crystal material disposed over the slot structure according to some embodiments.

FIG. 5 shows a cross-section view of a slot structure with FN liquid crystal material disposed over the slot structure and an alignment layer covering the slot structure according to some embodiments.

FIG. 6 shows a cross-section view of a slot structure with FN liquid crystal material disposed over the slot structure and an alignment layer disposed on the substrate adjacent to the FN liquid crystal material.

FIG. 7 shows a cross-section view of a slot structure with FN liquid crystal material disposed over the slot structure and two alignment layers according to some embodiments.

FIG. 8 shows a cross-section view of a slot structure with FN liquid crystal material disposed over the slot structure with two alignment layers and another substrate covering the cavity according to some embodiments.

FIG. 9 shows a cross-section view of a slot structure connected to a DC bias according to some embodiments.

FIG. 10 shows a top view of a slot structure with a gap between two electrodes that is filled with FN liquid crystal material according to some embodiments.

FIG. 11 shows a cross-section view of a slot structure with ferroelectric nematic (“FN”) liquid crystal material disposed over the slot structure according to some embodiments.

FIG. 12 shows a cross-section view of a slot structure with FN liquid crystal material disposed over the slot structure and an alignment layer covering the slot structure according to some embodiments.

FIG. 13 shows a cross-section view of a slot structure with FN liquid crystal material disposed over the slot structure and an alignment layer disposed on the substrate adjacent to the FN liquid crystal material.

FIG. 14 shows a cross-section view of a slot structure with FN liquid crystal material disposed over the slot structure and two alignment layers according to some embodiments.

FIG. 15 shows a cross-section view of a slot structure with FN liquid crystal material disposed over the slot structure with two alignment layers and another substrate covering the structure according to some embodiments.

FIG. 16 shows a cross-section view of a strip waveguide with no slot and with FN liquid crystal material disposed over the strip waveguide according to some embodiments.

FIG. 17 shows a cross-section view of a slot structure connected to a DC bias according to some embodiments.

### DETAILED DESCRIPTION

The present disclosure is directed to the use of ferroelectric nematic liquid crystals (“FN material”) in hybrid slot modulators.

Photonic integrated circuits allow photonic devices and electronic devices to be fabricated on a single chip. These circuits play a major role in the telecommunications industry. For example, photonic integrated circuits are used in worldwide communication networks, optical computing, optical processing, artificial intelligence, quantum computing, satellite antennas, light detection and ranging (LIDAR), and many more applications. Within photonic integrated circuits, electro-optical modulators may be used to convert information between the electrical and optical fields.

The field of silicon-organic hybrid (“SOH”) photonics utilizes the properties of electro-optical (“EO”) materials combined with traditional silicon-photonics technology. EO materials are foundational to a broad range of technology. For example, EO materials are used in displays, telecommunications, sensors, and other areas of technology. EO materials change their refractive index when an electric field is applied. Therefore, EO materials serve as in interface between electric fields and optical fields. Devices can be built utilizing EO materials to convert electrical signals to optical signals. One area of SOH photonics that has been of significant research interest is a silicon-based modulator that utilizes a slot waveguide and EO materials. These modulators may consist of doped silicon waveguides that are separated by a sub-wavelength distance. An EO material may be deposited in the slot, and if the refractive index is sufficiently lower than silicon the guided mode can be confined to the EO material.

Up until now, the EO material used within the slot waveguide has consisted of EO polymers. However, in order for EO polymers to act as modulators, a large external electric field must be applied to generate the appropriate orientation of the dipolar molecules. This poling procedure is sophisticated and has many disadvantages. First, the poling procedure is not easily reproducible. This makes the process inadequate for industrial applications. Second, the poling procedure is prone to thermodynamic instability. After the external voltage is removed, the molecules relax and return to the original random orientation. This leads to long-term stability issues. Therefore, there is a need for an electro-optic material that can be aligned without large electric field poling.

Ferroelectric nematic liquid crystals (“FN materials”) are a new class of electro-optic materials that offer superior properties as compared to conventional EO materials. FN materials contain molecules with dipoles along the long axis that spontaneously assemble into polar fluids with the dipoles aligned.

FN materials may be used in place of traditional EO polymers within SOH slot modulators to address the disadvantages associated with the required electric poling procedure. This substitution results in many key advantages. FN materials, like conventional nematic liquid crystals, have the benefit of being easily aligned. The use of FN materials within the slot modulator instead of EO polymers may result in the uniform alignment of the FN without the need for large electrical field poling. Optically uniform monodomains of FN liquid crystals can be obtained over large areas, either by applying a small DC field or by alignment with a thin alignment layer. Therefore, the focus of this invention includes filling the slot with FN materials instead of traditional EO polymers.

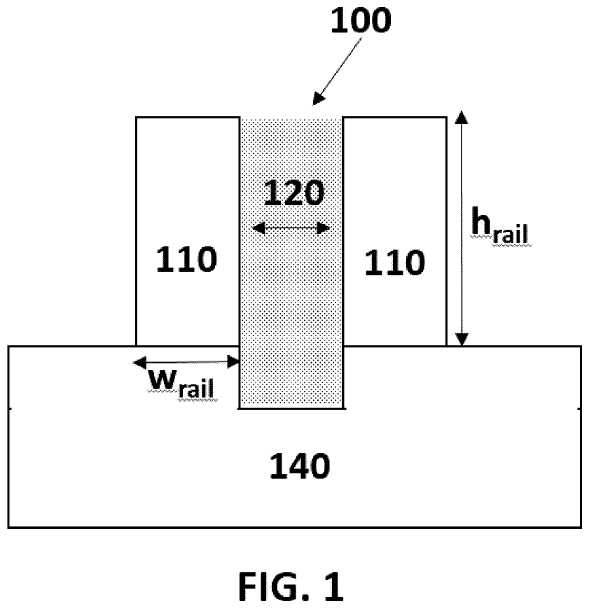

FIG. 1 shows a cross-section view of a slot structure 100 according to some embodiments. The slot structure 100 may be a slot waveguide. The slot structure 100 may be on a substrate 140. The substrate 140 may be made of non-EO material. In some cases, the substrate 140 may be a semiconductor. In some cases, the substrate 140 may comprise silicon. In some cases, the silicon may be doped. In some cases, the silicon may be un-doped. In some instances, the substrate 140 may have electronic components integrated therein. In some cases, the substrate 140 may be comprised of one or more layers. The substrate 140 may have a cavity defined therein. The slot structure 100 may be located within the cavity.

The slot structure 100 may comprise two or more rails 110. For example, in FIG. 1, the slot structure 100 contains two rails 110. Any number or type of rails may be contemplated. In some cases, the rails 110 may be made of silicon. In some cases, the rails 110 may be made of crystalline silicon. In some cases, the rails 110 may be made of silicon nitride. The rails 110 may extend longitudinally on the substrate 140. In some cases, the height of each rail, represented by hᵣₐᵢₗ in FIG. 1, is about 50 nanometers to about 1,000 nanometers. In some cases, the height of each rail is about 50 nanometers to about 100 nanometers, about 50 nanometers to about 200 nanometers, about 50 nanometers to about 500 nanometers, about 50 nanometers to about 1,000 nanometers, about 100 nanometers to about 200 nanometers, about 100 nanometers to about 500 nanometers, about 100 nanometers to about 1,000 nanometers, about 200 nanometers to about 500 nanometers, about 200 nanometers to about 1,000 nanometers, or about 500 nanometers to about 1,000 nanometers. In some cases, the height of each rail is about 50 nanometers, about 100 nanometers, about 200 nanometers, about 500 nanometers, or about 1,000 nanometers. In some cases, the height of each rail is at least about 50 nanometers, about 100 nanometers, about 200 nanometers, or about 500 nanometers. In some cases, the height of each rail is at most about 100 nanometers, about 200 nanometers, about 500 nanometers, or about 1,000 nanometers.

In some cases, the width of each rail, represented by wᵣₐᵢₗ in FIG. 1 is about 30 nanometers to about 800 nanometers. In some cases, the width of each rail is about 30 nanometers to about 100 nanometers, about 30 nanometers to about 200 nanometers, about 30 nanometers to about 500 nanometers, about 30 nanometers to about 800 nanometers, about 100 nanometers to about 200 nanometers, about 100 nanometers to about 500 nanometers, about 100 nanometers to about 800 nanometers, about 200 nanometers to about 500 nanometers, about 200 nanometers to about 800 nanometers, or about 500 nanometers to about 800 nanometers. In some cases, the width of each rail is about 30 nanometers, about 100 nanometers, about 200 nanometers, about 500 nanometers, or about 800 nanometers. In some cases, the width of each rail is at least about 30 nanometers, about 50 nanometers, about 100 nanometers, about 200 nanometers, or about 500 nanometers. In some cases, the width of each rail is at most about 100 nanometers, about 200 nanometers, about 500 nanometers, or about 800 nanometers.

The rails 110 may be spaced apart by a gap 130. In some embodiments, the distance of the gap 130 may be about 20 nanometers to about 500 nanometers. In some embodiments, the distance 130 may be about 20 nanometers to about 75 nanometers, about 20 nanometers to about 100 nanometers, about 20 nanometers to about 150 nanometers, about 20 nanometers to about 300 nanometers, about 20 nanometers to about 500 nanometers, about 75 nanometers to about 100 nanometers, about 75 nanometers to about 150 nanometers, about 75 nanometers to about 300 nanometers, about 75 nanometers to about 500 nanometers, about 100 nanometers to about 150 nanometers, about 100 nanometers to about 300 nanometers, about 100 nanometers to about 500 nanometers, about 150 nanometers to about 300 nanometers, about 150 nanometers to about 500 nanometers, or about 200 nanometers to about 500 nanometers. In some embodiments, the distance 130 may be about 20 nanometers, about 50 nanometers, about 75 nanometers, about 100 nanometers, about 150 nanometers, about 200 nanometers, about 300 nanometers, or about 500 nanometers. In some embodiments, the distance 130 may be at least about 20 nanometers, at least about 50 nanometers, about 75 nanometers, about 100 nanometers, about 150 nanometers, or about 200 nanometers. In some embodiments, the distance 130 may be at most about 75 nanometers, about 100 nanometers, about 150 nanometers, about 200 nanometers, about 300 nanometers, or about 500 nanometers. In some cases, the gap 130 may be filled with ferroelectric nematic (“FN”) liquid crystal material. The FN liquid crystal may be disposed in the cavity over the slot structure.

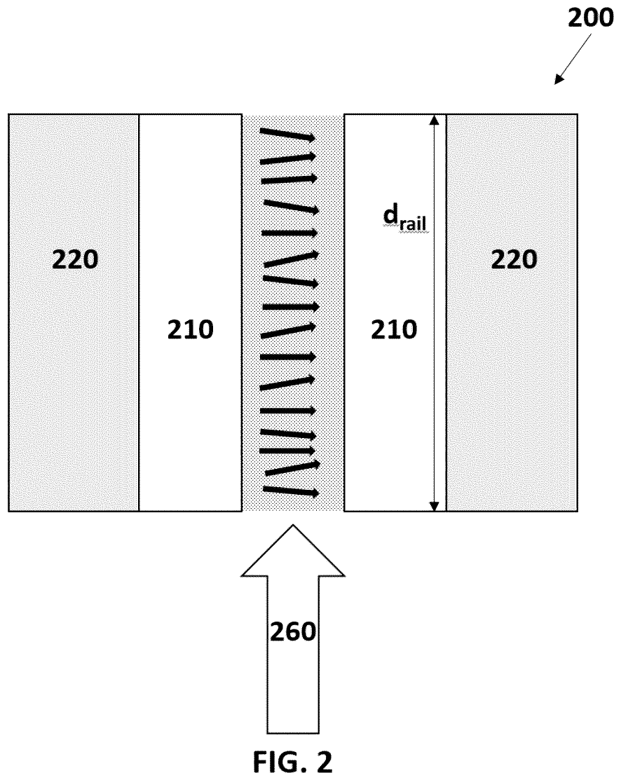

FIG. 2 shows a top view of a slot structure 200 filled with FN liquid crystal material according to some embodiments. The slot structure 200 may be a slot waveguide. The slot structure 200 may comprise two or more rails 210. In some instances, the rails 210 may be adjacent to a slab 220. In some cases, the slab 220 may be made of silicon. In some cases, the depth of each rail, represented by dᵣₐᵢₗ in FIG. 2, is about 50 nanometers to about 500 nanometers. In some cases, the depth of each rail is about 50 nanometers to about 100 nanometers, about 50 nanometers to about 200 nanometers, about 50 nanometers to about 500 nanometers, about 100 nanometers to about 200 nanometers, about 100 nanometers to about 500 nanometers, or about 200 nanometers to about 500 nanometers. In some cases, the depth of each rail is about 50 nanometers, about 100 nanometers, about 200 nanometers, or about 500 nanometers. In some cases, the depth of each rail is at least about 50 nanometers, about 100 nanometers, or about 200 nanometers. In some cases, the depth of each rail is at most about 100 nanometers, about 200 nanometers, or about 500 nanometers.

In some cases, the FN liquid crystal material may be aligned in the cavity over the slot structure such that a director of the FN liquid crystal material 260 is substantially perpendicular to a longitudinal axis of the slot structure 200. In some cases, the FN liquid crystal material may be aligned such that a director of the FN liquid crystal material 260 is substantially perpendicular to a longitudinal axis of the pair of rails 210.

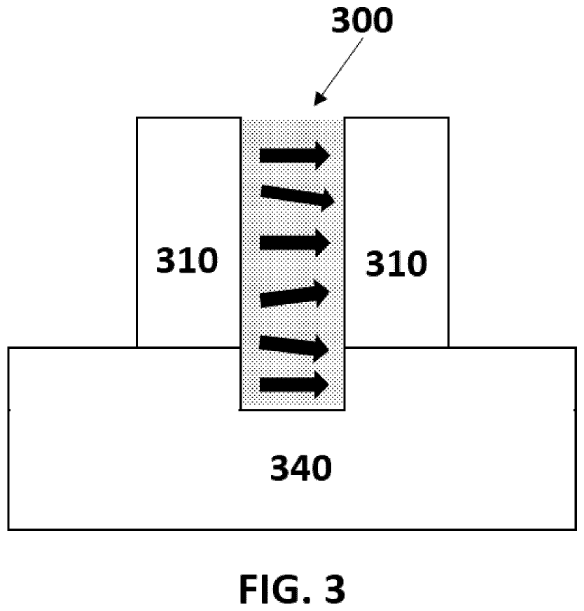

FIG. 3 shows a cross-section view of a slot structure 300 according to some embodiments. The slot structure 300 may be a slot waveguide. The slot structure 300 may be on a substrate 340. The substrate 340 may have a cavity defined therein. The slot structure 300 may be located within the cavity. The slot structure 300 may comprise two or more rails 310. For example, in FIG. 3, the slot structure 300 contains two rails 310. Any number or type of rails may be contemplated. In some cases, the rails 310 may be made of silicon. In some cases, the rails 310 may be made of crystalline silicon. The rails 310 may extend longitudinally on the substrate 340. The rails 310 may be spaced apart by a gap. In some cases, the gap may be filled with FN liquid crystal material. The FN liquid crystal may be disposed in the cavity over the slot structure. In some cases, the FN liquid crystal material may be aligned in the cavity over the slot structure such that a director of the FN liquid crystal material is substantially perpendicular to a longitudinal axis of the slot structure 300. In some cases, the FN liquid crystal material may be aligned such that a director of the FN liquid crystal material is substantially perpendicular to a longitudinal axis of the pair of rails 310. In some cases, the FN liquid crystal material may be aligned in a passive manner by introducing doping variations in the slot structure 300. In some instances, the pair of rails 310 may have different doping variations. In some cases, the pair of rails 310 may comprise a first rail having a first concentration of charge carriers, and a second rail having a second concentration of charge carriers that is greater or less than the first concentration.

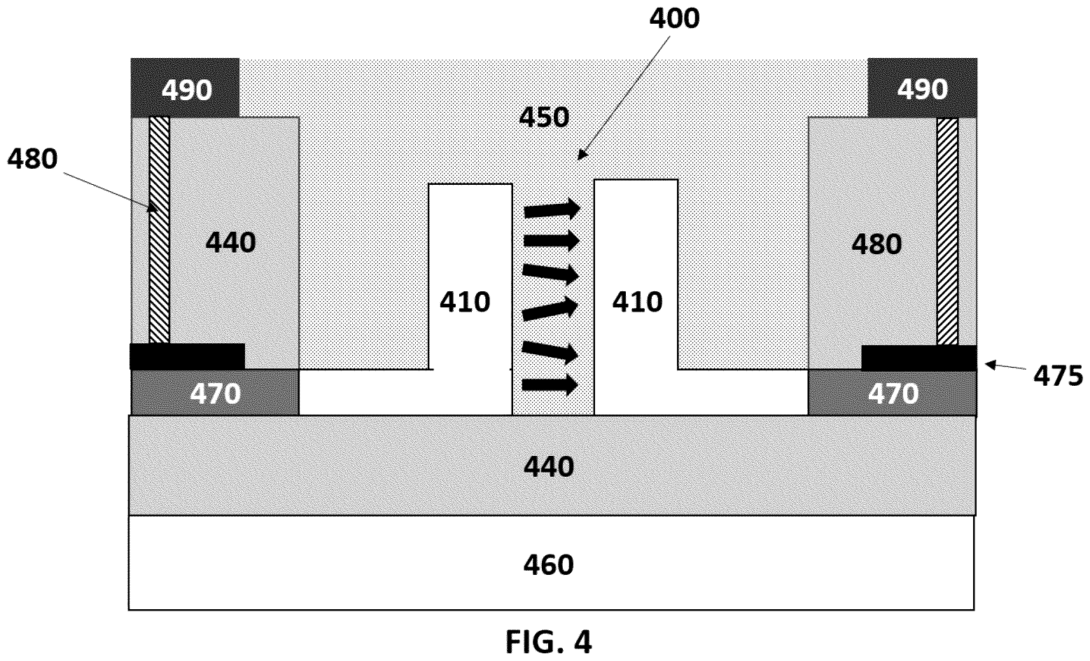

FIG. 4 shows a cross-section view of a slot structure 400 according to some embodiments. The slot structure 400 may be a slot waveguide. The slot structure 400 may be on a substrate 440. The substrate 440 may have a cavity defined therein. The slot structure 400 may be located within the cavity. The slot structure 400 may comprise two or more rails 410. For example, in FIG. 4, the slot structure 400 contains two rails 410. Any number or type of rails may be contemplated. In some cases, the rails 410 may be made of silicon. In some cases, the rails 410 may be made of crystalline silicon. The rails 410 may extend longitudinally on the substrate 440. The rails 410 may be spaced apart by a gap. In some cases, the gap may be filled with FN liquid crystal material. The FN liquid crystal may be disposed in the cavity over the slot structure. In some cases, the FN liquid crystal material may be aligned in the cavity over the slot structure such that a director of the FN liquid crystal material is substantially perpendicular to a longitudinal axis of the slot structure 400. In some cases, the FN liquid crystal material may be aligned such that a director of the FN liquid crystal material is substantially perpendicular to a longitudinal axis of the pair of rails 410. In some cases, the rails 410 may be disposed on a substrate 440. The substrate 440 may be made of non-EO material. In some cases, the substrate 440 may comprise silicon. In some cases, the silicon may be doped. In some cases, the silicon may be un-doped. In some cases, the substrate 440 comprises silicon dioxide. In some cases, the substrate 440 comprises silicon nitride. In some instances, the substrate 440 may have electronic components integrated therein. In some cases, the substrate 440 may comprise a plurality of layers. For example, a silicon oxide substrate 440 may be layered on top of a silicon substrate 460 as shown in FIG. 4. In some cases, the plurality of layers comprises one or more dielectric materials. In some cases, the plurality of layers comprises one or more electrically conductive materials.

In some cases, the slot structure 400 may be connected to two or more electrodes 490. The electrodes may be formed of various shapes and/or sizes. The electrodes may have a substantially square or rectangular shape, for example as shown in FIG. 4. In some embodiments, the electrodes may have a regular shape (e.g. polygonal shapes such as triangular, pentagonal, hexagonal, etc.) or an irregular shape. The electrodes may be of the same size or different sizes. The electrodes may have the same surface areas or different surface areas. The electrodes may be formed of a metal. For example, the electrodes may be made of aluminum. In some cases, the electrodes may be made of aluminum, gold, copper, graphite, titanium, brass, silver, or platinum, or any combination thereof. The slot structure 400 may be connected to the electrodes 490 through silicon strip-loads 470, silicide 475, and tungsten vias 480.

In some cases, the FN liquid crystal material may be aligned with aid of one or more alignment layers. In some cases, an alignment layer may be disposed on a first distal portion of the substrate cavity. In some cases, an alignment layer may be disposed at a second distal portion of the substrate cavity. In some cases, a first alignment layer may be disposed on a first distal portion of the substrate cavity and a second alignment layer may be disposed at a second distal portion of the substrate cavity. In some cases, the thickness of the alignment layer may be about 1 nanometer to about 20 nanometers. In some cases, the thickness of the alignment layer may be about 1 nanometer to about 2 nanometers, about 1 nanometer to about 5 nanometers, about 1 nanometer to about 10 nanometers, about 1 nanometer to about 20 nanometers, about 2 nanometers to about 5 nanometers, about 2 nanometers to about 10 nanometers, about 2 nanometers to about 20 nanometers, about 5 nanometers to about 10 nanometers, about 5 nanometers to about 20 nanometers, or about 10 nanometers to about 20 nanometers. In some cases, the thickness of the alignment layer may be about 1 nanometer, about 2 nanometers, about 5 nanometers, about 10 nanometers, or about 20 nanometers. In some cases, the alignment layers may be at least about 1 nanometer, about 2 nanometers, about 5 nanometers, or about 10 nanometers. In some cases, the thickness of the alignment layer may be at most about 2 nanometers, about 5 nanometers, about 10 nanometers, or about 20 nanometers. In some cases, one or more alignment layers may comprise a polymer. In some cases, one or more alignment layers may comprise silicon dioxide. In some cases, the silicon dioxide may be obliquely deposited relative to an orientation of the slot structure. In some cases, the polymer may be buffed polyimide. In some cases, the polymer may be a photoalignment polymer, like Rolic AG.

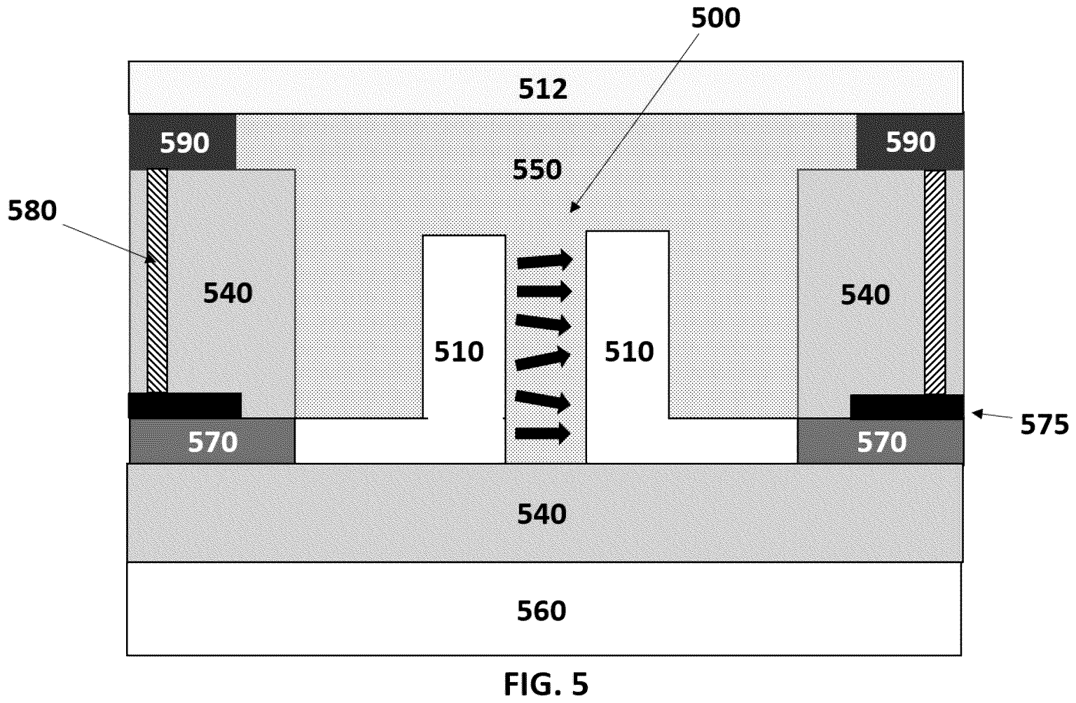

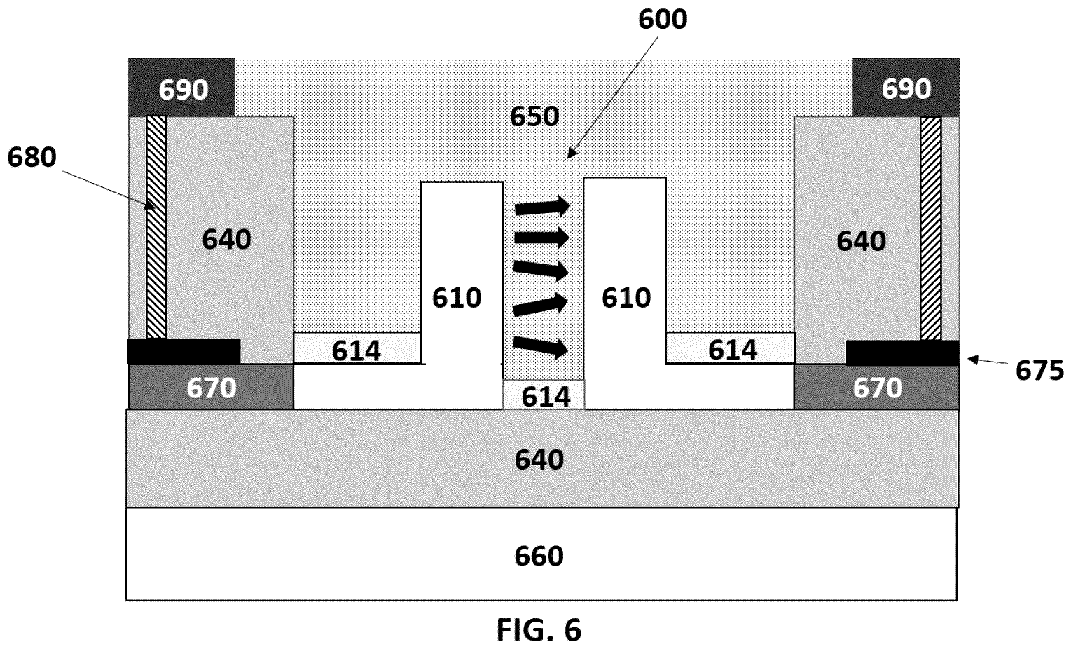

FIG. 5 shows a cross-section view of a slot structure 500 with an alignment layer 512 covering the slot structure 500 according to some embodiments. The slot structure 500 may be a slot waveguide. The alignment layer 512 may be parallel to the substrate 540. In some cases, the alignment layer 512 may be located on top of the electrodes 590. In some cases, the alignment layer 512 may be located adjacent to the FN liquid crystals 550. FIG. 6 shows a cross-section view of a slot structure 600 with an alignment layer 614 disposed on the substrate 640 adjacent to the FN liquid crystal material 650. The alignment layer 614 may be parallel to the substrate 640. In some instances, the alignment layer 614 may be adjacent to the rails 610. In some cases, the alignment layer 614 may be discontinuous, as shown in FIG. 6. In some cases, the alignment layer 614 is comprised of one or more different sections, as shown in FIG. 6. In some cases, two outer sections of the alignment layer 614 may be located on top of the rails 610. In some cases, the middle section of the alignment layer 614 may be located on top of the substrate 640. In some cases, the middle section of the alignment layer 614 may be located within the slot structure 600 and between rails 610. In some cases, the alignment layer 614 may be continuous. In some cases, the alignment layer 614 may be comprised of only one section.

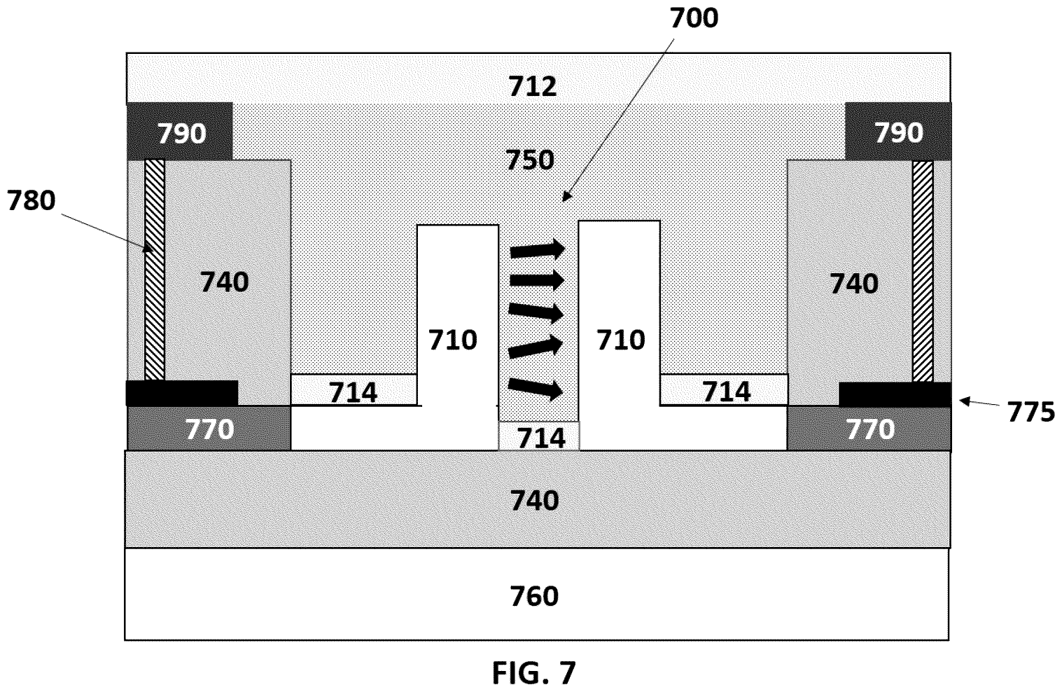

In some cases, two or more alignment layers may be used to align the FN liquid crystals. The two or more alignment layers may comprise a first alignment layer disposed at a first distal portion of the cavity and a second alignment layer disposed at a second distal portion of the cavity. FIG. 7 shows a cross-section view of a slot structure 700 with two alignment layers according to some embodiments. The slot structure 700 may be a slot waveguide. The first alignment layer 712 may cover the slot structure 500. The first alignment layer 712 may be parallel to the substrate 740. In some cases, the first alignment layer 712 may be located on top of the electrodes 790. In some cases, the first alignment layer 712 may be located adjacent to the FN liquid crystals 750. The second alignment layer 714 may be disposed on the substrate 740 adjacent to the FN liquid crystal material 750. The second alignment layer 714 may be parallel to the substrate 740. In some instances, the second alignment layer 714 may be adjacent to the rails 710. In some cases, the second alignment layer 714 may be discontinuous, as shown in FIG. 7. In some cases, the second alignment layer 714 is comprised of one or more different sections, as shown in FIG. 7. In some cases, two outer sections of the second alignment layer 614 may be located on top of the rails 610. In some cases, the middle section of the second alignment layer 614 may be located on top of the substrate 640. In some cases, the middle section of the second alignment layer 614 may be located within the slot structure 600 and between rails 610. In some cases, the second alignment layer 614 may be continuous. In some cases, the second alignment layer 614 may be comprised of only one section. The first alignment layer 712 may be parallel with the second alignment layer 714.

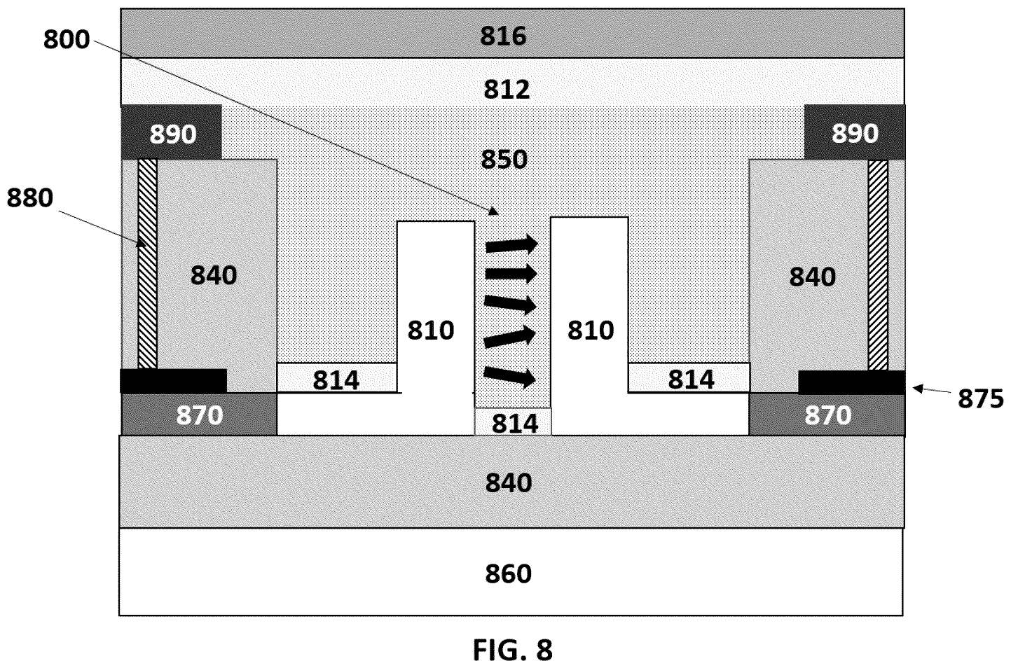

In some cases, an alignment layer may be disposed on another substrate covering the cavity. FIG. 8 shows a cross-section view of a slot structure 800 with two alignment layers and another substrate covering the cavity according to some embodiments. Referring to FIG. 8, the alignment layer 812 may be disposed on another substrate 816. In some cases, the substrate 816 may be a cover glass. In some cases, the substrate 816 may comprise silicate glass. In some cases, the substrate 816 may be parallel to the substrate 640. In some instances, the anisotropy direction of the alignment layers may be parallel between the substrate 816 and substrate 840. In some instances, the anisotropy direction of the alignment layers may be non-parallel between the substrate 816 and substrate 840.

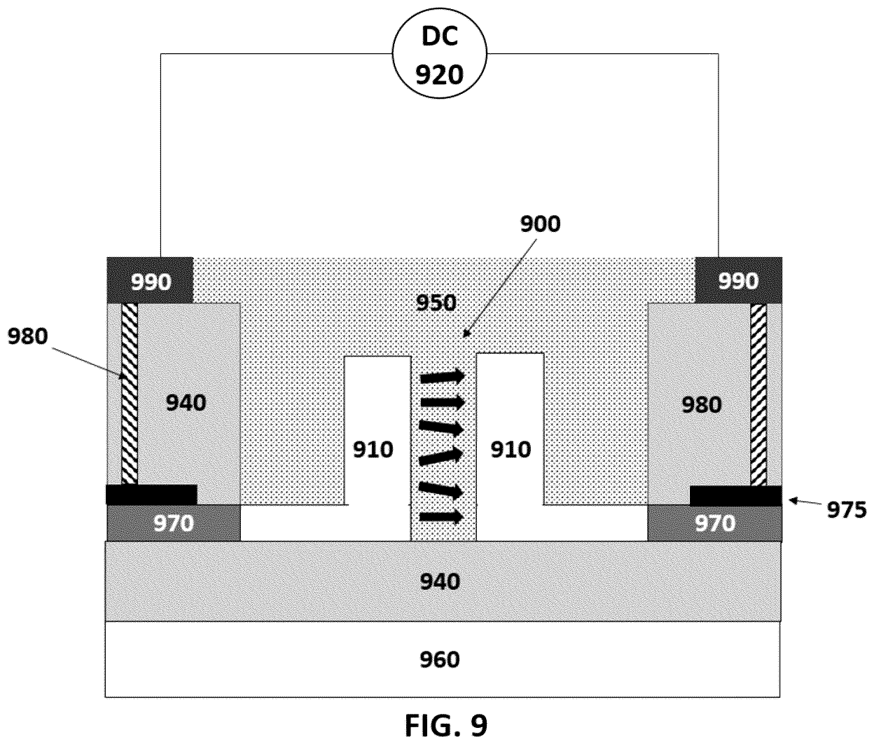

In some instances, the FN liquid crystal materials may be aligned with aid of a direct current (DC) bias. FIG. 9 shows a slot structure 900 that may be attached to a DC field 920. The slot structure 900 may be a slot waveguide. The DC bias may leave a permanent DC field on the slot structure 900. In some embodiments, the DC field may be applied long enough to create a monodomain of aligned FN material. In some cases, the DC bias may orient the director of the FN liquid crystal material 950 in the desired configuration, perpendicular to the rails 910. The DC bias may be less than or equal to 1 V/um. In some cases, the DC bias may be about 0.01 V/um to about 1 V/um. In some cases, the DC bias may be about 0.01 V/um to about 0.05 V/um, about 0.01 V/um to about 0.1 V/um, about 0.01 V/um to about 0.5 V/um, about 0.01 V/um to about 1 V/um, about 0.05 V/um to about 0.1 V/um, about 0.05 V/um to about 0.5 V/um, about 0.05 V/um to about 1 V/um, about 0.1 V/um to about 0.5 V/um, about 0.1 V/um to about 1 V/um, or about 0.5 V/um to about 1 V/um. In some cases, the DC bias may be about 0.01 V/um, about 0.05 V/um, about 0.1 V/um, about 0.5 V/um, or about 1 V/um. In some cases, the DC bias may be at least about 0.01 V/um, about 0.05 V/um, about 0.1 V/um, or about 0.5 V/um. In some cases, the DC bias may be at most about 0.05V/um, about 0.1 V/um, about 0.5 V/um, or about 1 V/um. In some instances, the DC field may be connected to the slot structure 900 through two or more electrodes 990. The electrodes may be formed of various shapes and/or sizes. The electrodes may have a substantially square or rectangular shape, for example as shown in FIG. 9. In some embodiments, the electrodes may have a regular shape (e.g. polygonal shapes such as triangular, pentagonal, hexagonal, etc.) or an irregular shape. The electrodes may be of the same size or different sizes. The electrodes may have the same surface areas or different surface areas. The electrodes may be formed of a metal. For example, the electrodes may be made of aluminum. In some cases, the electrodes may be made of aluminum, copper, graphite, titanium, brass, silver, or platinum, or any combination thereof. The slot structure 900 may be connected to the electrodes 990 through silicon strip-loads 970, silicide 975, and tungsten vias 980.

The field of plasmonic-organic hybrid (“POH”) photonics utilizes the properties of electro-optical (“EO”) materials combined with the area of plasmonics. Plasmonics refers to the guiding and detection of surface plasmon polaritons (“SPPs.”) A POH modulator consists of two metal pads separated by a distance. This distance, often referred to as a slot, is filled with EO polymer. A nanowire guides light through the metal pads to the slot. This results in a great amount of overlap between the optical and electrical fields within the slot.

FN materials may be used in place of traditional EO polymers within POH slot modulators to address the disadvantages associated with the required electric poling procedure. This substitution results in many key advantages. The use of FN materials within the slot modulator instead of EO polymers may result in the electrical alignment of the slot material without the need for large electrical field poling. Therefore, the focus of this invention includes filling the slot with FN materials instead of traditional EO polymers.

FN materials may be used in plasmonic-organic hybrid (“POH”) slot modulators. POH slot modulators use a slot waveguide to create overlap between electric and optical fields. The slot waveguide may consist of two electrodes separated by a distance. This distance may be referred to as a slot. Traditionally, the slot may be filled with EO polymers. The focus of this invention includes filling the slot with FN materials instead of traditional EO polymers. This substitution results in many key advantages. The use of FN materials within the slot modulator instead of EO polymers may result in the electrical alignment of the slot material without the need for large electrical field poling.

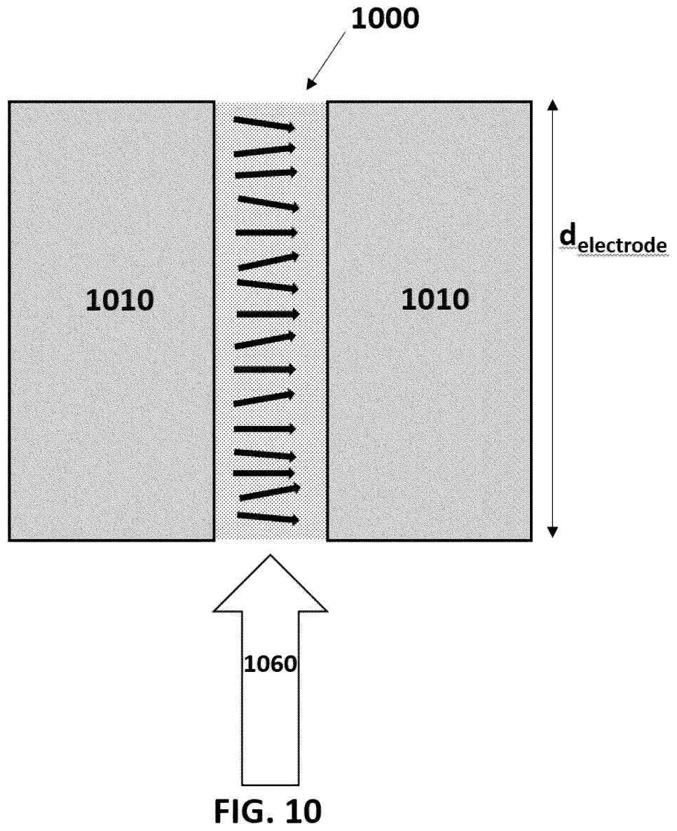

FIG. 10 shows a top view of a slot structure 1000 filled with FN liquid crystal material according to some embodiments. The slot structure 1000 may be a slot waveguide. In some cases, the FN liquid crystal material may be aligned in the cavity over the slot structure such that a director of the FN liquid crystal material 1060 is substantially perpendicular to a longitudinal axis of the slot structure 1000. In some cases, the FN liquid crystal material may be aligned such that a director of the FN liquid crystal material 1060 is substantially perpendicular to a longitudinal axis of the pair of electrodes 1010. In some instances, a nanowire may be coupled through a metal taper to the one or more slots. In some cases, the nanowire may comprise silicon.

In some cases, the depth of each electrode, represented by d_{electrode} in FIG. 10, is about 5 nanometers to about 50 nanometers. In some cases, the depth of each electrode is about 5 nanometers to about 10 nanometers, about 5 nanometers to about 20 nanometers, about 5 nanometers to about 50 nanometers, about 10 nanometers to about 20 nanometers, about 10 nanometers to about 50 nanometers, or about 20 nanometers to about 50 nanometers. In some cases, the depth of each electrode is about 5 nanometers, about 10 nanometers, about 20 nanometers, or about 50 nanometers. In some cases, the depth of each electrode is at least about 5 nanometers, about 10 nanometers, or about 20 nanometers. In some cases, the depth of each electrode is at most about 10 nanometers, about 20 nanometers, or about 50 nanometers.

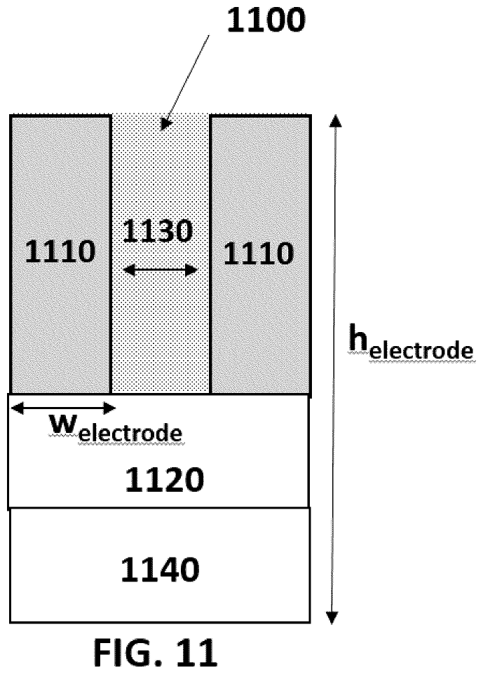

FIG. 11 shows a cross-section view of a slot structure 1110 according to some embodiments. The slot structure 1100 may be a slot waveguide. The slot structure 1100 may be on a substrate 1120. The substrate 1120 may be made of non-EO material. In some cases, the substrate 1120 may be a semiconductor. In some cases, the substrate 1120 may comprise silicon. In some cases, the silicon may be doped. In some cases, the silicon may be un-doped. In some instances, the substrate 1120 may have electronic components integrated therein. In some cases, the substrate 140 may be comprised of one or more layers. The slot structure 1100 may comprise two or more electrodes 1110. For example, in FIG. 11, the slot structure 1100 contains two electrodes 1110. Any number or type of electrodes may be contemplated. The electrodes 1110 may be formed of various shapes and/or sizes. The electrodes may have a substantially square or rectangular shape, for example as shown in FIG. 11. In some embodiments, the electrodes may have a regular shape (e.g. polygonal shapes such as triangular, pentagonal, hexagonal, etc.) or an irregular shape. The electrodes may be of the same size or different sizes. The electrodes may have the same surface areas or different surface areas. The electrodes may be formed of a metal. For example, the electrodes may be made of gold. In some cases, the electrodes may be made of aluminum, copper, graphite, titanium, brass, silver, or platinum, or any combination thereof. The electrodes 1110 may extend longitudinally on a substrate 1120. In some cases, the substrate 1120 may comprise silicon dioxide. In some cases, the substrate 1120 comprises silicon nitride. In some cases, the substrate may comprise a plurality of layers. For example, a silicon dioxide substrate 1120 may be layered on top of a silicon substrate 1140 as shown in FIG. 11. In some cases, the plurality of layers comprises one or more dielectric materials. In some cases, the plurality of layers comprises one or more electrically conductive materials.

In some cases, the height of each electrode, represented by h_{electrode} in FIG. 11, is about 50 nanometers to about 1,000 nanometers. In some cases, the height of each electrode is about 50 nanometers to about 100 nanometers, about 50 nanometers to about 200 nanometers, about 50 nanometers to about 500 nanometers, about 50 nanometers to about 1,000 nanometers, about 100 nanometers to about 200 nanometers, about 100 nanometers to about 500 nanometers, about 100 nanometers to about 1,000 nanometers, about 200 nanometers to about 500 nanometers, about 200 nanometers to about 1,000 nanometers, or about 500 nanometers to about 1,000 nanometers. In some cases, the height of each electrode is about 50 nanometers, about 100 nanometers, about 200 nanometers, about 500 nanometers, or about 1,000 nanometers. In some cases, the height of each electrode is at least about 50 nanometers, about 100 nanometers, about 200 nanometers, or about 500 nanometers. In some cases, the height of each electrode is at most about 100 nanometers, about 200 nanometers, about 500 nanometers, or about 1,000 nanometers.

The electrodes 1110 may be spaced apart by a gap 1130. In some cases, the gap 1130 may be about 20 nanometers to about 300 nanometers. In some cases, the gap 1130 may be about 20 nanometers to about 40 nanometers, about 20 nanometers to about 50 nanometers, about 20 nanometers to about 100 nanometers, about 20 nanometers to about 200 nanometers, about 20 nanometers to about 300 nanometers, about 40 nanometers to about 50 nanometers, about 40 nanometers to about 100 nanometers, about 40 nanometers to about 200 nanometers, about 40 nanometers to about 300 nanometers, about 50 nanometers to about 110 nanometers, about 50 nanometers to about 200 nanometers, about 50 nanometers to about 300 nanometers, about 110 nanometers to about 200 nanometers, about 100 nanometers to about 300 nanometers, or about 200 nanometers to about 300 nanometers. In some cases, the gap 1130 may be about 20 nanometers, about 30 nanometers, about 40 nanometers, about 50 nanometers, about 100 nanometers, about 200 nanometers, or about 300 nanometers. In some cases, the gap 1130 may be at least about 20 nanometers, about 40 nanometers, about 50 nanometers, about 100 nanometers, or about 200 nanometers. In some cases, the gap 1130 may be at most about 40 nanometers, about 50 nanometers, about 100 nanometers, about 200 nanometers, or about 300 nanometers. In some cases, the gap 1130 may be filled with ferroelectric nematic (“FN”) liquid crystal material. In some cases, the gap may be filled with FN liquid crystal material. The FN liquid crystal may be disposed over the slot structure. In some cases, the FN liquid crystal material may be aligned over the slot structure such that a director of the FN liquid crystal material is substantially perpendicular to a longitudinal axis of the slot structure 1100. In some cases, the FN liquid crystal material may be aligned such that a director of the FN liquid crystal material is substantially perpendicular to a longitudinal axis of the pair of electrodes 1110.

In some cases, the FN liquid crystal material may be aligned with aid of one or more alignment layers. In some cases, one or more alignment layers may be disposed on a first distal portion of the substrate. In some cases, the one or more alignment layers may be disposed at a second distal portion of the substrate. In some cases, the alignment layers may be about 1 nanometer to about 20 nanometers. In some cases, the alignment layers may be about 1 nanometer to about 2 nanometers, about 1 nanometer to about 5 nanometers, about 1 nanometer to about 10 nanometers, about 1 nanometer to about 20 nanometers, about 2 nanometers to about 5 nanometers, about 2 nanometers to about 10 nanometers, about 2 nanometers to about 20 nanometers, about 5 nanometers to about 10 nanometers, about 5 nanometers to about 20 nanometers, or about 10 nanometers to about 20 nanometers. In some cases, the alignment layers may be about 1 nanometer, about 2nanometers, about 5 nanometers, about 10 nanometers, or about 20 nanometers. In some cases, the alignment layers may be at least about 1 nanometer, about 2 nanometers, about 5 nanometers, or about 10 nanometers. In some cases, the alignment layers may be at most about 2 nanometers, about 5 nanometers, about 10 nanometers, or about 20 nanometers. In some cases, one or more alignment layers may comprise a polymer. In some cases, one or more alignment layers may comprise silicon dioxide. In some cases, the silicon dioxide may be obliquely deposited relative to an orientation of the slot structure. In some cases, the polymer may be buffed polyimide. In some cases, the polymer may be a photoalignment polymer, like Rolic AG.

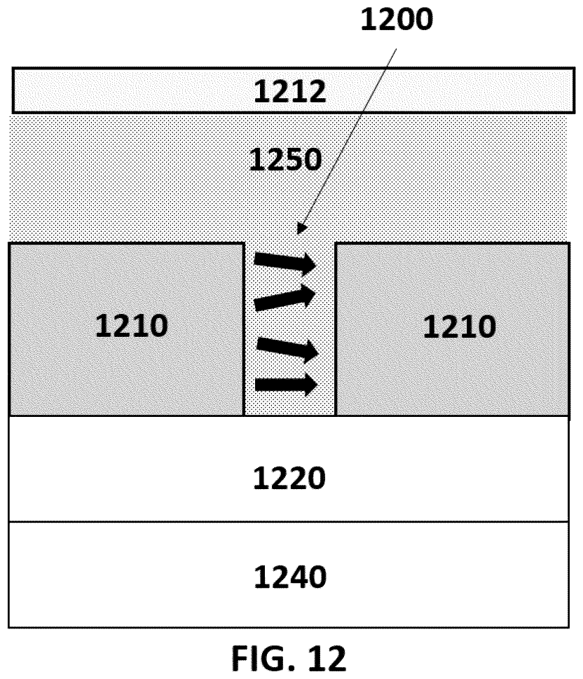

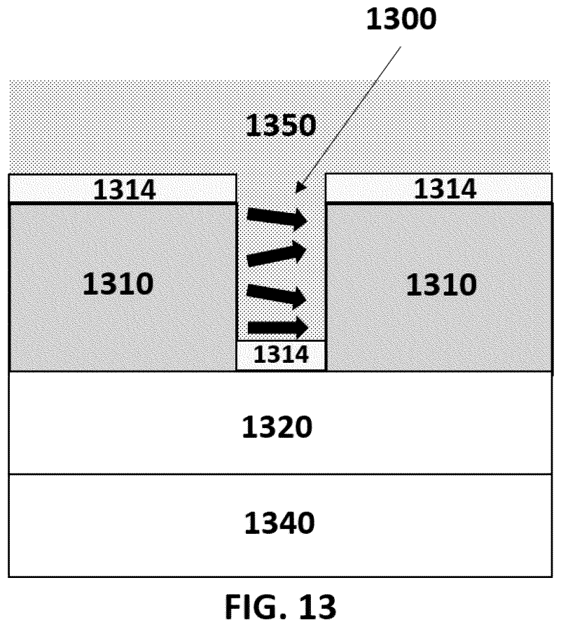

FIG. 12 shows a cross-section view of a slot structure 1200 with an alignment layer 1212 covering the slot structure 1200 according to some embodiments. The slot structure 1200 may be a slot waveguide. The alignment layer 1212 may be parallel to the substrate 1220. In some cases, the alignment layer 1212 may be located adjacent to the FN liquid crystals 1250. FIG. 13 shows a cross- section view of a slot structure 1300 with an alignment layer 1314 disposed on the substrate 1340 adjacent to the FN liquid crystal material 1350. The alignment layer 1314 may be parallel to the substrate 1320. In some instances, the alignment layer 1314 may be adjacent to the electrodes 1310. In some cases, the alignment layer 1314 may be discontinuous, as shown in FIG. 13. In some cases, the alignment layer 1314 is comprised of one or more different sections, as shown in FIG. 13. In some cases, two outer sections of the alignment layer 1314 may be located on top of the electrodes 1310. In some cases, the middle section of the alignment layer 1314 may be located on top of the substrate 1320. In some cases, the middle section of the alignment layer 1314 may be located within the slot structure 1300 and between electrodes 1310. In some cases, the alignment layer 1314 may be continuous. In some cases, the alignment layer 1314 may be comprised of only one section.

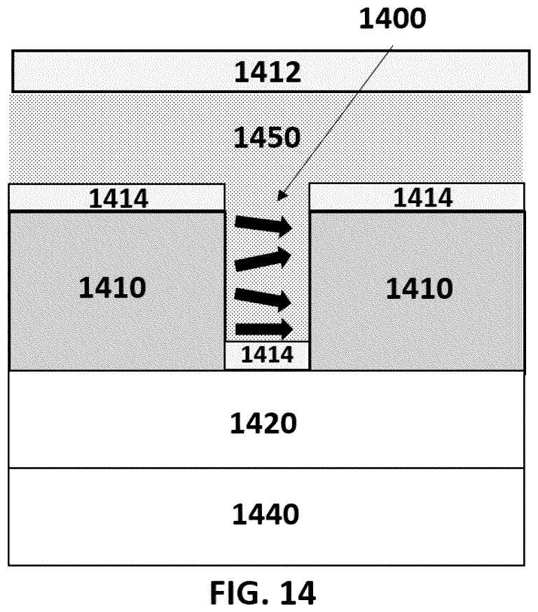

In some cases, two or more alignment layers may be used to align the FN liquid crystals. The two or more alignment layers may comprise a first alignment layer disposed at a first distal portion of the cavity and a second alignment layer disposed at a second distal portion of the cavity. FIG. 14 shows a cross-section view of a slot structure 1400 with two alignment layers according to some embodiments. The slot structure 1400 may be a slot waveguide. The first alignment layer 1412 may cover the slot structure 1400. The first alignment layer 1412 may be parallel to the substrate 1420. In some cases, the first alignment layer 1412 may be located adjacent to the FN liquid crystals 1450. The second alignment layer 1414 may be disposed on the substrate 1420 adjacent to the FN liquid crystal material 1450. The second alignment layer 1414 may be parallel to the substrate 1420. In some instances, the second alignment layer 1414 may be adjacent to the electrodes 1410. In some cases, the second alignment layer 1414 may be discontinuous, as shown in FIG. 14. In some cases, the second alignment layer 1414 is comprised of one or more different sections, as shown in FIG. 14. In some cases, two outer sections of the second alignment layer 1414 may be located on top of the electrodes 1410. In some cases, the middle section of the second alignment layer 1414 may be located on top of the substrate 1420. In some cases, the middle section of the second alignment layer 1414 may be located within the slot structure 1400 and between electrodes 1410. In some cases, the second alignment layer 1414 may be continuous. In some cases, the second alignment layer 1314 may be comprised of only one section. The first alignment layer 1412 may be parallel with the second alignment layer 1414.

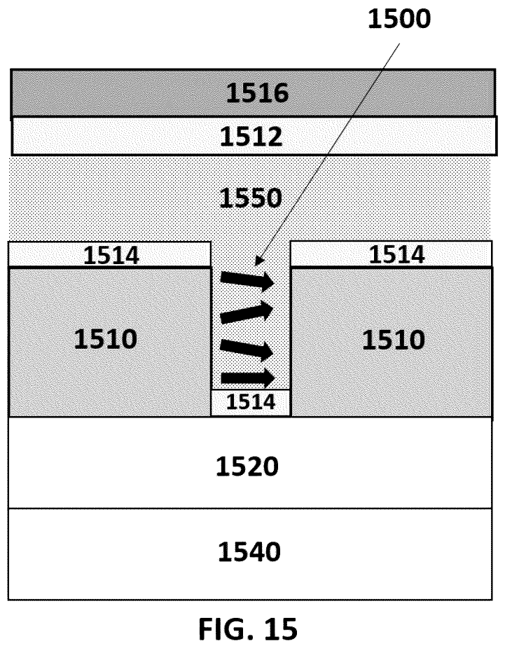

In some cases, an alignment layer may be disposed on another substrate covering the cavity. FIG. 15 shows a cross-section view of a slot structure 1500 with two alignment layers and another substrate covering the cavity according to some embodiments. Referring to FIG. 15, the alignment layer 1512 may be disposed on another substrate 1516. In some cases, the substrate 1516 may be a cover glass. In some cases, the substrate 1516 may comprise silicate glass. In some cases, the substrate 1516 may be parallel to the substrate 1520. In some instances, the anisotropy direction of the alignment layers may be parallel between the substrate 1516 and substrate 1520. In some instances, the anisotropy direction of the alignment layers may be non-parallel between the substrate 1516 and substrate 1520.

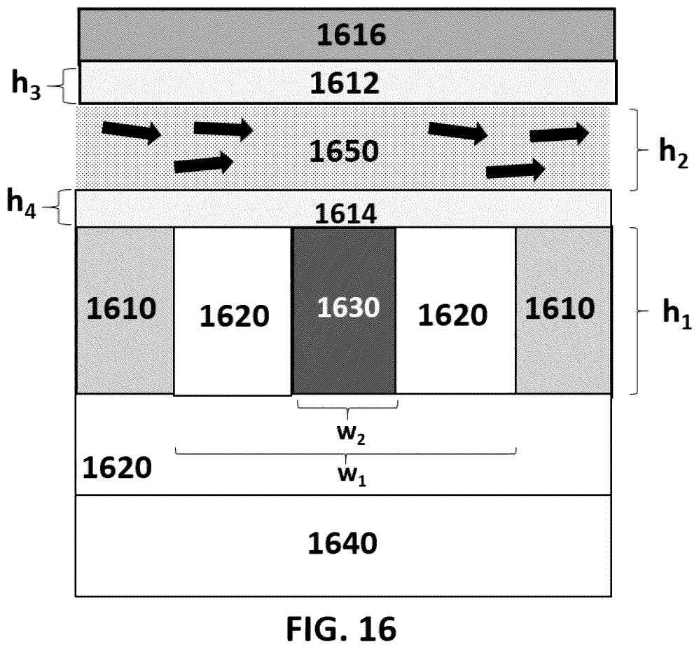

In some cases, a strip waveguide can be absent of slot. FIG. 16 shows a cross-section view of a strip waveguide 1630 without a slot according to some embodiments. The strip waveguide can be comprised of silicon nitride (SiN), silicon (Si), or tantalum pentoxide (Ta₂O₅). In some cases, the width of the strip waveguide, represented by w₂ in FIG. 16, is less than 2 μm. The strip waveguide may be on a substrate 1620. The substrate 1620 can be on either side of strip waveguide 1630. In some cases, the width of the strip waveguide 1630 and substrate 1620 on both sides, represented by w₁ in FIG. 16, is less than 20 μm. The substrate 1620 may be made of non-EO material. The substrate 1620 may be made of any transparent dielectric with a lower index than the material used in the waveguide 1630. The substrate 1620 may be made of silicon dioxide (SiO₂), a polymer, or aluminum oxide (Al₂O₃). In some cases, the substrate 1620 may be a semiconductor. In some cases, the substrate 1620 may comprise silicon. In some cases, the silicon may be doped. In some cases, the silicon may be un-doped. In some instances, the substrate 1620 may have electronic components integrated therein. In some cases, the substrate 1620 may be comprised of one or more layers. The strip waveguide 1630 may comprise two or more electrodes 1610. Any number or type of electrodes may be contemplated. The electrodes 1610 may be formed of various shapes and/or sizes. The electrodes may have a substantially square or rectangular shape, for example as shown in FIG. 16. In some embodiments, the electrodes may have a regular shape (e.g. polygonal shapes such as triangular, pentagonal, hexagonal, etc.) or an irregular shape. The electrodes may be of the same size or different sizes. The electrodes may have the same surface areas or different surface areas. The electrodes may be formed of a metal. For example, the electrodes may be made of gold. In some cases, the electrodes may be made of aluminum, copper, graphite, titanium, brass, silver, or platinum, or any combination thereof. The electrodes 1610 may extend longitudinally on a substrate 1620. In some cases, the substrate 1620 may comprise silicon dioxide. In some cases, the substrate 1620 comprises silicon dioxide (SiO₂). In some cases, the substrate may comprise a plurality of layers. For example, a silicon dioxide substrate 1620 may be layered on top of a silicon substrate 1640 as shown in FIG. 16. In some cases, the plurality of layers comprises one or more dielectric materials. In some cases, the plurality of layers comprises one or more electrically conductive materials.

In some cases, ferroelectric nematic (“FN”) liquid crystal material 1650 is disposed over the strip waveguide 1630. The height of the FN liquid crystal material 1650, represented by h₂, may be less than 20 μm. In some cases, the FN liquid crystal material may be aligned over the strip waveguide such that a director of the FN liquid crystal material is substantially perpendicular to a longitudinal axis of the strip waveguide 1630. In some cases, the FN liquid crystal material may be aligned such that a director of the FN liquid crystal material is substantially perpendicular to a longitudinal axis of the pair of electrodes 1610. In some cases, the height of each electrode, represented by h₁ in FIG. 16, is less than 1 μm.

In some cases, the FN liquid crystal material may be aligned with aid of one or more alignment layers. In some cases, one or more alignment layers may be disposed on a first distal portion of the substrate. In some cases, the one or more alignment layers may be disposed at a second distal portion of the substrate. A first alignment layer 1612 may be parallel to the substrate 1620. In some cases, the alignment layer 1612 may be located adjacent to the FN liquid crystals 1650. The height of the alignment layer 1612, represented by h₃, may be less than 50 nm. A second alignment layer 1614 can be disposed on the substrate 1620 adjacent to the FN liquid crystal material 1650. The alignment layer 1614 may be parallel to the substrate 1620. In some instances, the alignment layer 1614 may be adjacent to the electrodes 1610. In some cases, the alignment layer 1614 may be continuous, as shown in FIG. 16. The height of the alignment layer 1614, represented by h₄, may be less than 50 nm. In some cases, an alignment layer may be disposed on another substrate covering the cavity. The alignment layer 1612 may be disposed on another substrate 1616. In some cases, the substrate 1616 may be a cover glass. In some cases, the substrate 1616 may comprise silicate glass. In some cases, the substrate 1616 may be parallel to the substrate 1620. In some instances, the anisotropy direction of the alignment layers may be parallel between the substrate 1616 and substrate 1620. In some instances, the anisotropy direction of the alignment layers may be non-parallel between the substrate 1616 and substrate 1620. A strip waveguide with no slot can keep the waveguide and electrodes all in a plane so a user can spincoat a polymer easily.

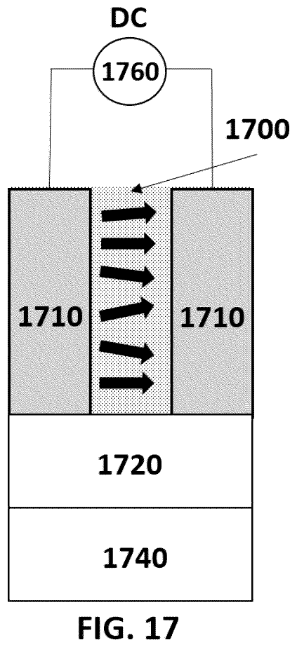

In some instances, the FN liquid crystal materials may be aligned with aid of a direct current (DC) bias. FIG. 17 shows a slot structure 1700 that may be attached to a DC field 1760. The slot structure 1700 may be a slot waveguide. The DC bias may leave a permanent DC field on the slot structure 1700. In some embodiments, the DC field may be applied long enough to create a monodomain of aligned FN material. In some cases, the DC bias may orient the director of the FN liquid crystal material in the desired configuration, perpendicular to the electrodes 1710. The DC bias may be less than or equal to 1 V/um. In some cases, the DC bias may be about 0.01 V/um to about 1 V/um. In some cases, the DC bias may be about 0.01 V/um to about 0.05 V/um, about 0.01 V/um to about 0.1 V/um, about 0.01 V/um to about 0.5 V/um, about 0.01 V/um to about 1 V/um, about 0.05 V/um to about 0.1 V/um, about 0.05 V/um to about 0.5 V/um, about 0.05 V/um to about 1 V/um, about 0.1 V/um to about 0.5 V/um, about 0.1 V/um to about 1 V/um, or about 0.5 V/um to about 1 V/um. In some cases, the DC bias may be about 0.01 V/um, about 0.05 V/um, about 0.1 V/um, about 0.5 V/um, or about 1 V/um. In some cases, the DC bias may be at least about 0.01 V/um, about 0.05 V/um, about 0.1 V/um, or about 0.5 V/um. In some cases, the DC bias may be at most about 0.05 V/um, about 0.1 V/um, about 0.5 V/um, or about 1 V/um. In some instances, the DC field may be connected to the slot structure 1700 through two or more electrodes 1710. The electrodes may be formed of various shapes and/or sizes. The electrodes may have a substantially square or rectangular shape, for example as shown in FIG. 17. In some embodiments, the electrodes may have a regular shape (e.g. polygonal shapes such as triangular, pentagonal, hexagonal, etc.) or an irregular shape. The electrodes may be of the same size or different sizes. The electrodes may have the same surface areas or different surface areas. The electrodes may be formed of a metal. For example, the electrodes may be made of gold. In some cases, the electrodes may be made of gold, aluminum, copper, graphite, titanium, brass, silver, or platinum, or any combination thereof.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A device comprising:
a slot structure on a substrate;
a plurality of layers on the substrate having a cavity defined therein, wherein the slot structure is located within the cavity; and
a ferroelectric nematic (FN) liquid crystal material disposed in the cavity over the slot structure.
